(19) United States
(12) Patent Application Publication
(10) Pub. No.: US 2020/0058986 A1
(43) Pub. Date: Feb. 20, 2020

(54) MODULAR AND MASSIVELY SCALABLE ANTENNA ARRAYS

(71) Applicant: Taoglas Group Holdings Limited, San Diego, CA (US)

(72) Inventor: Jason Philip Dorsey, San Diego, CA (US)

(21) Appl. No.: 16/485,751

(22) PCT Filed: Feb. 12, 2018
(86) PCT No.: PCT/US2018/017768

§ 371 Date: Aug. 13, 2019

Related U.S. Application Data
(60) Provisional application No. 62/458,255, filed on Feb. 13, 2017.

(51) Int. Cl. H01Q 1/24; H01Q 1/48; H01Q 1/42; H01Q 21/00

(52) U.S. Cl. CPC H01Q 1/246; H01Q 21/0025; H01Q 1/42; H01Q 1/48

(57) ABSTRACT

A rapidly and easily deployable system of antennas described. The antennas are joined to each other in a manner that allows quick and simple assembly, replaceability and scalability of the system.

### CROSS-REFERENCE

This application claims the benefit of U.S. Provisional Application No. 62/458,255, filed Feb. 13, 2017, entitled MODULAR AND MASSIVELY SCALABLE ANTENNA ARRAYS, which application is incorporated herein by reference.

### BACKGROUND

Referring to FIG. 1, there is seen a base station 101 within a communications network. Base station 101 is comprised of antennas that enable a plurality of devices 102 to communicate with each other. In one embodiment, devices 102 communicate within the network using well known 1G, 2G, 3G, 4G and/or 4G LTE (Long Term Evolution). In the future, 5G is considered as the technology that will be capable of supporting communications between the large number of devices that are envisioned to be used in an internet-of-things (IOT). When deployed, in the system of FIG. 1, 5G networks will require scalability on an as needed basis to accommodate an ever increasing number of such IOT devices, which may number hundreds of thousands or even more devices. It would therefore be useful to find simple apparatus and methods by which networks can be scaled to include the large numbers of additional antennas and transceivers that will be required for devices and users to communicate with each other in IOT.

### SUMMARY

In one embodiment, the disclosure comprises: a system of M housings, where M is equal to or greater than 2, each housing comprised of at least a ground plane, each housing being coupled to at least one other housing to form an array that is self-supporting in free space. In one embodiment the array comprises a periphery, the periphery defined by at least one of the M housings. In one embodiment at least one of the M housings comprises at least one antenna. In one embodiment at least one antenna comprises an assembly of antennas. In one embodiment the assembly of antennas comprises a plurality of antennas disposed in a grid like orientation relative to one another, and wherein a center to center spacing between each antenna in the grid relative to a spatially opposite antenna in the grid is substantially the same. In one embodiment at least one of the M housings is not comprised of any antennas. In one embodiment the periphery is defined by the at least one of M housings that is not comprised of any antenna. In one embodiment the plurality of housings not comprised of any antennas is coupled to the periphery if of least one of the M housings comprised of at least one antenna. In one embodiment the antennas comprises a plurality of antennas disposed in a grid like orientation relative to one another, and wherein a center to center spacing between each antenna in the grid relative to a spatially opposite antenna in the grid is substantially the same. In one embodiment at least one of the M housings comprises at least one antenna. In one embodiment at least one antenna comprises a plurality of antennas, where adjacent ones of the plurality of antennas are all separated by substantially the same distance. In one embodiment a plurality of the plurality of antennas defines a periphery. In one embodiment at least one of the M housings is not comprised of any antennas. In one embodiment at least one of the M housings not comprised of any antennas is disposed in the array opposite the periphery defined by the plurality of antennas. In one embodiment at least one of the M housings not comprised of any antennas is coupled to the periphery defined by the plurality of antennas. In one embodiment all the M housings in the array comprise the same width and the same length. In one embodiment all the M housings in the array have an exterior surface defined by at least one fastening structure that is used to fasten adjacent housings in the array to each other. In one embodiment all the M housings in the array have an exterior surface defined by at least one fastening structure, where in the array, adjacent housings are joined to each other by at least one of the at least one fastening structure, wherein when joined together, the at least one fastening structure defines at least a portion of an aperture that is adapted to receive a fastener. In one embodiment the system comprises a communications system. In one embodiment the communications system comprises a 1G, 2G, 3G, 4G or 5G system.

In one embodiment, the disclosure comprises a method of assembling a system of M housings, where M is an integer greater than or equal to 2, each housing comprised of at least a ground plane, the method comprising; coupling a first of the M housings to a second of the M housings to form an array that is self-supporting in free space. In one embodiment each of the housings comprise an exterior surface defined by at least one fastening structure, where the step of coupling comprises joining the respective fastening structure of the first housing to a respective fastening structure of the second housing. In one embodiment at least one fastening structure comprises at least one of a protrusion and a recess. In one embodiment the step of coupling comprises a step of joining a recess of the first housing with a protrusion of the second housing. In one embodiment step of coupling comprises a step of forming an aperture. In one embodiment the step of coupling further comprises a step of inserting a fastener within the aperture. In one embodiment the first housing comprises at least one antenna module and the second housing comprises no antenna module. In one embodiment the at least one antenna module comprises a plurality of adjacent antennas, where adjacent antennas are all separated by the same distance.

In one embodiment, the disclosure comprises a method of forming an antenna array, the method comprising the steps of: providing X housings, wherein X is a integer that greater than or equal to 2, wherein Y of the housings comprise antennas, and wherein Y is equal to or less than X; and coupling the X housings together into an array that is self-supporting in free space. In one embodiment the X housings comprise ground planes. In one embodiment wherein after the X housings are coupled, the ground planes are disposed in a common plane. In one embodiment each of the Y of the X housings comprise a length A and a width B and a remainder of the housings defined by X minus Y comprise a length C and a width D. In one embodiment A and C are the same and B and D are the same. In one embodiment A and B are different. In one embodiment B and D are different. In one embodiment. In one embodiment after being coupled, X minus Y of the housings form a perimeter around the Y housings. In one embodiment the step of coupling comprises a step of sliding at least one of the housings along the common plane into any position in the array. In one embodiment the step of coupling comprises a step of dropping at least one of the housings down vertically relative to the common plane into any position in the array.

In one embodiment, the disclosure comprises an antenna module, the antenna module comprised of: a first housing having an exterior surface adapted to be mated to at least a second housing to form a self-supporting array of housings. In one embodiment the antenna module further comprising a plurality of antennas, wherein the plurality of antennas are disposed in a grid like a pattern such that all adjacent antennas in grid are separated by the same distance. In one embodiment the distance is 28 mm. In one embodiment the distance effectuates operation of the antenna module at a frequency of between 5.375-6.375 GHz.

In one embodiment, the disclosure comprises: a system comprised of at least M antenna housings, where M is equal to or greater than 2, each antenna housing being coupled to at least one other antenna housing to form an array of antenna housings that is self-supporting in free space. In one embodiment adjacent antenna housings are coupled to each other by one or more threadless fastener. In one embodiment M is at least 2 and N is at least 2.

In one embodiment, the disclosure comprises: a system of M antenna modules, where M is an integer that is equal to or greater than 2, each module comprised of: a housing having an exterior surface defined by at least one fastening structure, where in the array, adjacent housings are joined to each other by their respective at least one fastening structure, wherein when joined together, both the at least one fastening structure of each housing defines an aperture that is adapted to receive a fastener. In one embodiment the system comprises the fastener. In one embodiment the fastener is a pin. In one embodiment the fastener is threadless. In one embodiment with the fastener inserted within the aperture, the at least two modules form an array that is self-supporting. In one embodiment the housing comprises a ground plane. In one embodiment the ground plane comprises a conductive material. In one embodiment the conductive material comprises an elastomer. In one embodiment the conductive material is disposed around a periphery of the ground plane. In one embodiment the modules comprise at least one antenna. In one embodiment the system comprises a communications system. In one embodiment the system comprises a cellular communications network. In one embodiment the system comprises a Massive Multiple-input and Multiple-output (MIMO) antenna system. In one embodiment the communications system comprises a 1G, 2G, 3G, 4G or 5G network. In one embodiment the M housings define an array comprised of rows and column, wherein any housing within a particular row and column of the array can be decoupled from the row and column that it is in without requiring movements of other housings in the array that are not in the particular row and the particular column of the array.

In one embodiment, the disclosure comprises: an antenna module, the antenna module comprised of: a first housing having an exterior surface defined by at least one fastening structure adapted to be mated to at least one fastening structure of a second housing, wherein when mated, the at least one fastening structure of the first housing defines at least a portion of an aperture. In one embodiment the module comprises a ground plane. In one embodiment the module comprises an antenna module. In one embodiment the ground plane comprises a conductive material disposed on the ground plane.

In one embodiment, the disclosure comprises: a system of M modules, where M is equal to or greater than 2, each module comprised of: a housing; an antenna assembly; a ground plane; and a conductive material, the housing having an exterior surface defined by a fastening structure comprised of at least one protrusion and at least one recess, the housing being joined to the ground plane, and the ground plane being joined to the antenna assembly, wherein the fastening structure of the housing mates with the fastening structure of at least one other housing in the system. In one embodiment when mated, the fastening structures of two adjacent housings define at least one aperture. In one embodiment the disclosure at least one fastener disposed within the aperture. In one embodiment the fastening structure is comprised of at least one protrusion and at least one recess. In one embodiment the conductive material is disposed within a groove formed in a periphery of the ground plane. In one embodiment the M modules are physically coupled to form an array comprised of rows and columns of modules that are joined by a respectively coupling of at least one protrusion or at least one recess of at least one module within the array with at least one recess or at least one protrusion of at least one other module in the array. In one embodiment the conductive material defines a periphery of each module, wherein the conductive material of each module in the array is physically coupled to the conductive material of at least one other module in the array to enable electrical conductivity between all the ground planes in the array. In one embodiment conductive material comprises an elastomer. In one embodiment any module within a particular row and column of the array can be decoupled from the row and column that it is in without requiring removal of other modules in the array that are not in the particular row and the particular column.

In one embodiment, the disclosure comprises: a system comprised of a at least a first housing and at least a second housing, where an exterior surface of each housing is defined by at least one protrusion and at least one recess, wherein a fitment of at least one protrusion of the first housing within at least one recess of the second housing couples the first housing to the second housing. In one embodiment the system comprises an array comprised of M housings, where M is equal to or greater than 2. In one embodiment at least some of the housings comprise an antenna assembly. In one embodiment the antenna assembly comprises a plurality of individual antennas disposed in a grid like orientation relative to one another, and wherein a center to center spacing between each individual antenna in the grid relative to spatially opposite antennas in the grid is substantially the same. In one embodiment all the individual antennas in the array are disposed center to center relative to one another in the grid like orientation, and wherein a center to center spacing between each individual antenna in the array relative to spatially opposite antennas in the array is substantially the same. In one embodiment a center to center spacing is 28 mm. In one embodiment a center to center spacing of effectuates operation of the antennas between 5.375-6.375 GHz. In one embodiment the exterior surface of each of the M housings is defined by two sets of opposing sides, wherein at least one side of each of the housings of the M housings is coupled to a side of an adjacent housing via fitment of its at least one protrusion within the at least one of the recess of the adjacent housing. In one embodiment the exterior surface of each the M housings is defined by two sets of opposing sides, wherein at least one side of each of the housings of the M housings is coupled to a side of an adjacent housing via fitment of its at least one recess over the at least one protrusion of the adjacent housing. In one embodiment when coupled, the at least one recess and at least one protrusion define an aperture adapted to receive a fastener. In one embodiment the fastener comprises a threadless fastener.

In one embodiment, the disclosure comprises: a system of M modules used to form an antenna array, wherein M is greater than or equal to 2, each module comprised of: a ground plane and a conductive material disposed around a periphery of the ground plane, wherein all the ground planes in the array make physical contact with each other. In one embodiment the conductive material is disposed within a groove formed in the periphery of the ground plane. In one embodiment in the array, wherein the physical contact between ground planes is effectuated by the conductive material. In one embodiment the conductive material is an elastomer. In one embodiment all the ground planes of all the modules in the array are electrically connected via physical contact made between conductive material disposed on adjacent modules in the array. In one embodiment the antennas operate at a frequency of between 5.375-6.375 GHz. In one embodiment the center to center spacing effectuates operation of the antennas at frequencies below 5.375 GHz. In one embodiment the center to center spacing effectuates operation of the antennas at frequencies above 6.375 GHz.

In one embodiment, the disclosure comprises: a communications system comprised of: a plurality of antennas disposed on a substrate in a grid like orientation relative to one another, wherein a center to center spacing between each antenna in the grid relative to a spatially opposite antenna in the grid is substantially the same. In one embodiment the system further comprises a plurality of housings, where the antennas are mounted directly to at least some of the housings. In one embodiment the center to center spacing is 28 mm. In one embodiment the center to center spacing of effectuates operation of the antennas at frequencies between 5.375-6.375 GHz. In one embodiment the disclosure further comprising a periphery, wherein the antennas are disposed within the periphery, and wherein the substrate comprises a ground plane connected to a ground, wherein the ground plane encircles the periphery. In one embodiment the ground plane is self-supporting in free space. In one embodiment the center to center spacing is less than 28 mm. In one embodiment the center to center spacing is more than 28 mm.

In one embodiment, the present disclosure comprises: a method of assembling a system comprised of modules arranged to form m columns and n rows, where n and m are selected from the set of integers that effectuate at least 2 modules being used in the system, and where each module is comprised of: a housing having a top surface, a bottom surface, and an end surface; an antenna assembly; a ground plane; and a conductive gasket, the housing having an exterior surface defined by a fastening structure comprised of at least one protrusion and at least one recess, the housing being coupled to the ground plane, and ground plane being coupled to the antenna assembly, wherein the fastening structure of the housing mates with the fastening structure of at least one other housing in the system, the method comprising the steps of: coupling a first housing to a second housing, where relative to a plane along which the top surface of the second housing is disposed, a protrusion of the first housing is positioned within a first recess of the second housing during the coupling via downward movement of the first housing toward the plane until the top surfaces of the first and second housings become substantially aligned along the plane. In one embodiment, the method further comprises: where and after substantially aligning the top surfaces of the first and second housings, positioning the protrusion of the first housing within a second recess of the second housing along the plane until the end surfaces of the first and second housings become substantially aligned.

In one embodiment, the present disclosure comprises: a method of assembling a system comprised of modules arranged to form m columns and n rows, where n and m are selected from the set of integers that effectuate at least 2 modules being used in the system, and where each module is comprised of: a housing having a top surface, a bottom surface, and an end surface; an antenna assembly; a ground plane; and a conductive gasket disposed around a periphery of the ground plane, the housing having an exterior surface defined by a fastening structure comprised of at least one protrusion and at least one recess, the housing being coupled to the ground plane, and ground plane being coupled to the antenna assembly, wherein the fastening structure of the housing mates with the fastening structure of at least one other housing in the system, the method comprising the steps of: coupling a first housing to a second housing, aligning top surfaces of the first and second housing substantially along a common plane, moving the first housing along the plane such a protrusion of first housing is received by a recess of the second housing and until the end surfaces of the first and second housings become substantially aligned.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a representation of a prior art system within which the present disclosure may be used;

FIGS. 2A-E are representations of modules of the present disclosure implemented as arrays with different configurations;

FIGS. 3A-B are a top and side view representation of an embodiment of a module of the present disclosure;

FIG. 4 is a representation of an embodiment comprised of three housings of the present disclosure;

FIGS. 5A-B and 6A-B are a top and side view representation of an embodiment of comprised of two housings of the present disclosure;

FIGS. 7A-B are a side view representation showing contact being made between the conductive material on adjacent ground planes;

FIG. 8A is a representation of a spacing between all antennas in an array comprised of the modules of the present disclosure;

FIG. 8B is a representation of a cross-sectional end view of two adjacent ground planes of the present disclosure;

FIG. 9 is a representation showing connector holes in a housing of the present disclosure;

FIG. 10 is a representation of a perspective view of a module of the present disclosure; and

FIGS. 11A-D are a representation of a ground plane of the disclosure from a top side, a bottom side, a first side and a second side.

### DETAILED DESCRIPTION

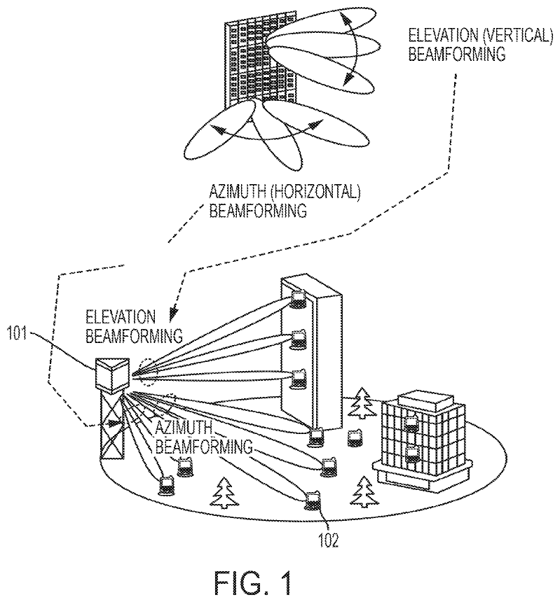

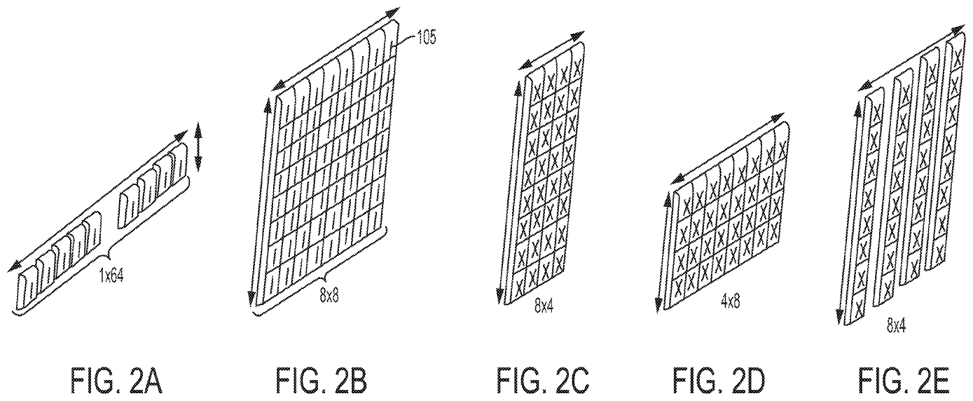

Referring to FIGS. 2A-E, there is seen a plurality of modules configured in arrays having different configurations, where the arrays are intended to be used in a system comprised of a communication network, for example, the network of FIG. 1. In one embodiment, an exemplary module 105 is indicated to be arranged within an array of M×N such modules, where M and N are selected from the set of integers that effectuate at least 2 modules being used in the network. For example, as shown in FIGS. 2A-E, arrays may be comprised of 1×64, 8×8, 8×4, 4×8 and 8×4 modules. However the disclosure should not be considered to be limited by FIGS. 2A-E, as arrays comprised of any M×N modules are considered to be within the scope of the disclosure, for example, with as many modules 105 as may be needed to effectuate communication in a 1G, 2G, 3G, 4G and/or 4G LTE network, or in a 5G system, where in a 5G system it is anticipated the modules would be used to implement a massive multiple input-multiple-output (Massive MIMO) antenna system.

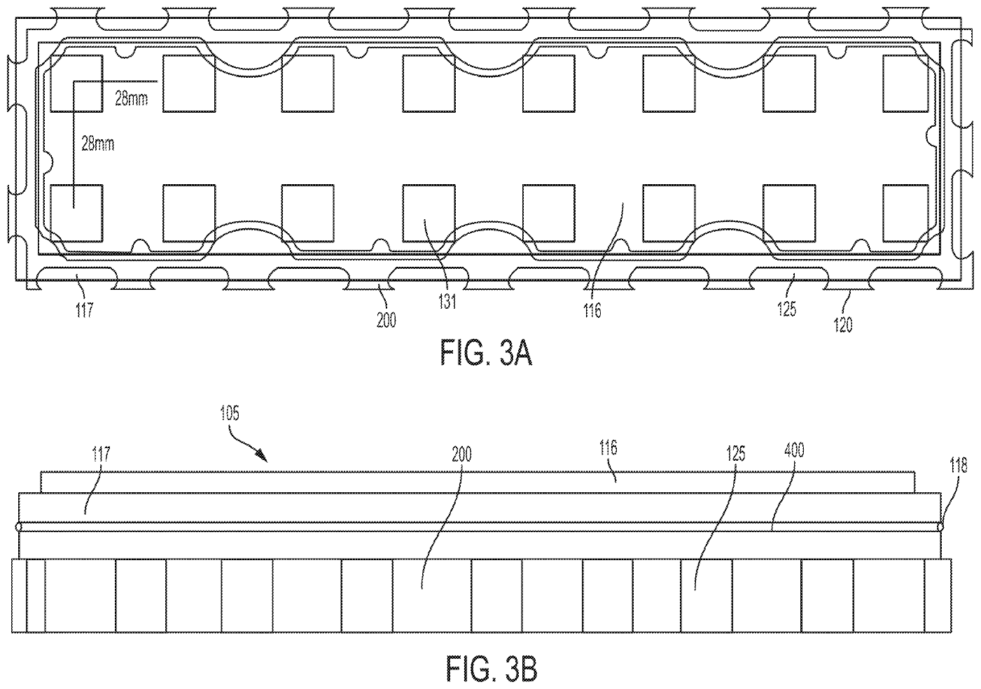

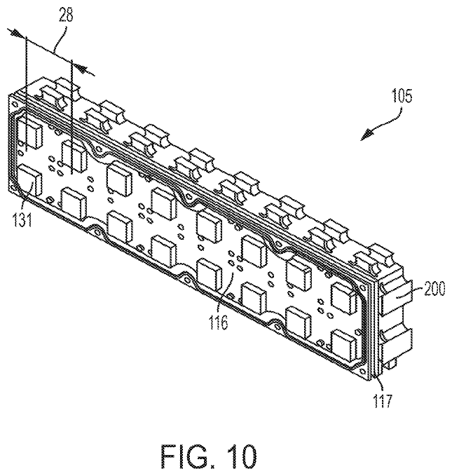

Referring to FIGS. 3A-B, there is seen a representation of a top and a side view of one embodiment of a module of the present disclosure and referring to FIG. 10, there is seen a perspective view of one embodiment of a module of the present disclosure. Module 105 can comprise a housing 200, a ground plane 117 and an antenna module 116 comprised of at least one antenna 131. In one embodiment, the ground plane 117 defines an end portion of housing 200. In one embodiment the ground plane 117 is initially manufactured as a separate structure. In one embodiment, the ground plane 117 and the housing 200 are formed together at the same time as an integral unit. Where the housing and the ground plane are manufactured as separate units, before the housing and the ground plane are joined together, a conductive gasket or conductive O-ring (not shown) is placed between the housing and the ground pane to improve electrical conductivity therebetween. An exterior surface of the housing 200 of the module 105 can be defined by at least one protrusion 120 and at least one recess 125. In the side view of FIGS. 3A-B, the ground plane 117 includes a groove 400 within which a conductive material 118 is disposed. The groove 400 can comprise a dovetailed groove. The conductive material can comprise an elastomer. In some configurations, the elastomer extends around the entire periphery of the ground plane 117. In one embodiment, the conductive material comprises a conductive elastomeric O-ring and/or gasket that extend outward from the periphery by about 0.3 mm. Alternatively, instead of a groove and conductive gasket, the sides of the ground plane can be specially treated or coated with a material to enhance conductivity. The special treatment or coating can extend around the periphery in the form of a band that encircles the ground plane. The housing 200 can be made of any suitable conductive material, for example, aluminum, stainless steel, or other material with dimensions sufficient to provide structural support, rigidity and/or other performance characteristics. The ground plane 117 is made of a conductive material, for example, aluminum, stainless steel, or other material with dimensions sufficient to provide structural support, rigidity, and/or good ground plane performance. In one embodiment, the antenna module 116 comprises a plurality of antennas 131, for example 16 antennas. The dimensions of the antennas 131 can be 12 mm square. Antennas 131 are positioned on the antenna module with respect to each other and with respect to the housing 200. A grid like spacing between adjacent antennas can be provided which is equal to a half wavelength, for example, a spacing of 28 mm, which enables the antennas to operate with 10 db RL frequency of operation around 5.375-6.375 GHz with best performance around 5.8-6 GHz where the antenna X-pol is around −30 dB. As will be appreciated by those skilled in the art, the dimensions of the antenna module 116 may be changed so as accommodate different antennas, different operating frequencies, and different sized electrical connections and traces thereon, where it is further understood that one or more other dimensions of a module 105 comprised of an antenna module 116 that has been resized and could be changed as may be needed to accommodate the particular geometry of the antenna module as well as to enable the functionality described above and below.

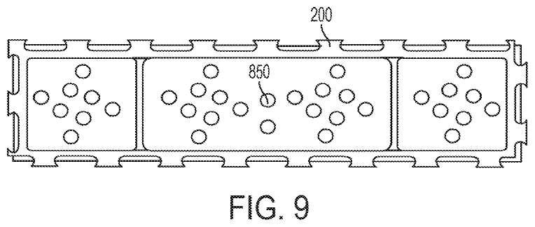

The antenna module 116 can be configured to comprise at least one antenna connector (not shown) coupled to at least one antenna 131. In an assembled condition of the module 105, antenna connectors 130 of antenna module 116 are configurable to be inserted within one or more openings 850 (also shown in FIG. 9) provided in ground plane 117 and/or housing 200, where after insertion in the holes, the connectors would extend out the openings within an interior of housing 200. In one embodiment the connectors are SMA-F connectors.

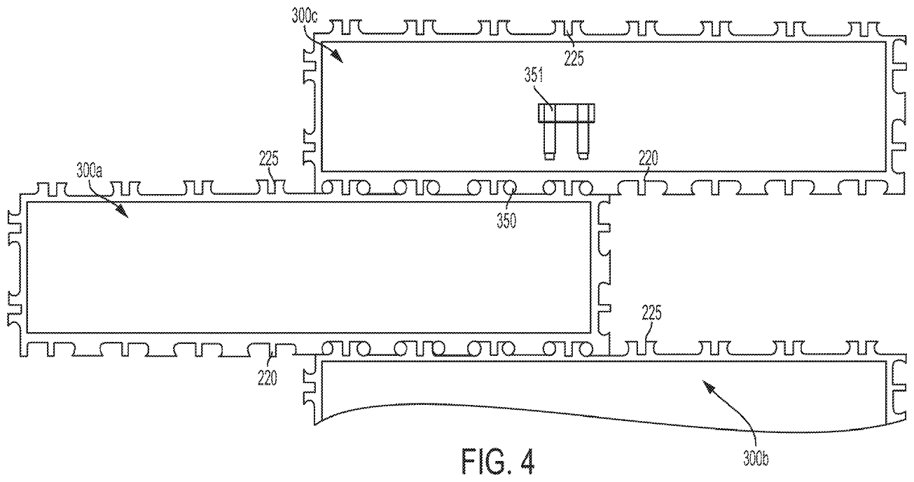

Referring to FIG. 4, there are seen three housings 300a-c of the present disclosure. In FIG. 4, each housing of a respective module comprises fastening structures comprised of at least one protrusion 220 and at least one recess 225, each having different configuration from that shown in FIGS. 3A-B. In FIG. 4, there is seen that at least one protrusion 220 of a first housing 300c may be positioned within a recess 225 of a second housing 300a. In one configuration, where a bottom surface of the second housing 300a has been previously positioned along a plane, first housing 300c and at least one of its protrusions 220 may be positioned into at least one recess 225 of the second housing 300a via downward positioning of the first housing 300c until a bottom surface of the first housing 300c becomes substantially aligned in the same plane as a bottom surface of the second housing 300a. With respect to a previously fixed orientation of the second housing 300a, the first housing 300c and all its respective protrusions 220 can be positioned downward into respective ones of all the recesses 225 of the second housing 300a, where after doing so, the bottom and ends of 300a and 300c would be substantially aligned along common planes. The system can be comprised of more than three housings, for example, housings 300a-c, adjacent housings may be joined to each other via coupling of their respective protrusions 220 and respective mating recesses 225. Although FIG. 4 illustrates an offset orientation of housing 300a with respect to housing 300c and housing 300b, other orientations and configurations are within the scope of the disclosure, including but not limited to, a configuration where adjacent ends of adjacent housings are aligned in the same plane. For example, an array of housings joined in the manner described above can form an array having a rectangular or square periphery.

Although described with respect to FIG. 4, the above discussion is understood to apply to drop-in insertion and or pull-out removal of any housing from any position in any array comprised of housings having fastening structures as is described herein. Thus, via the movements and interaction of the protrusions and recesses described above, the present disclosure enables modules to be easily and quickly positioned into vacant positions of an array of modules. After positioning one module relative to one or more other modules, a final fixed orientation of the modules may be achieved without the need for threaded fasteners. Where the fastening structures of the housings have a machined geometry along their periphery as shown in FIG. 4, after being joined in the manner shown in FIG. 4, the combination of the geometry of the fastening structure of each housing causes one or more 350 hole to be formed or otherwise defined. The apertures or holes 350 are circular. After a desired position of one housing relative to another housing is achieved, the housings may be further coupled together via use of one or more additional fastening structure. In one embodiment, the fastening structure comprises a fastener. In one embodiment, the fastening structure comprises one or more pin 351. The one or more pins may comprise a spring loaded metal ball bearing on its shaft for forming a detent with a matching structure along walls of the hole 350. With one or more pin inserted with one or more of the holes formed by the one or more fastening structures of adjacent housings, with appropriate dimensioning tolerances given to the holes and fastener, the present disclosure enables the resulting array to act as a substantially rigid unit that is self-supporting, in free space or otherwise, without necessarily requiring that the array be supported by any other structure to achieve self-support. Self-supporting arrays as enabled by the present disclosure, comprised only of housings and coupling structures and/or fasteners as described herein, or in combination with mounted antenna modules, can easily assembled away from a difficult to reach base station and thereafter be easily mounted in self-supported form on the base station.

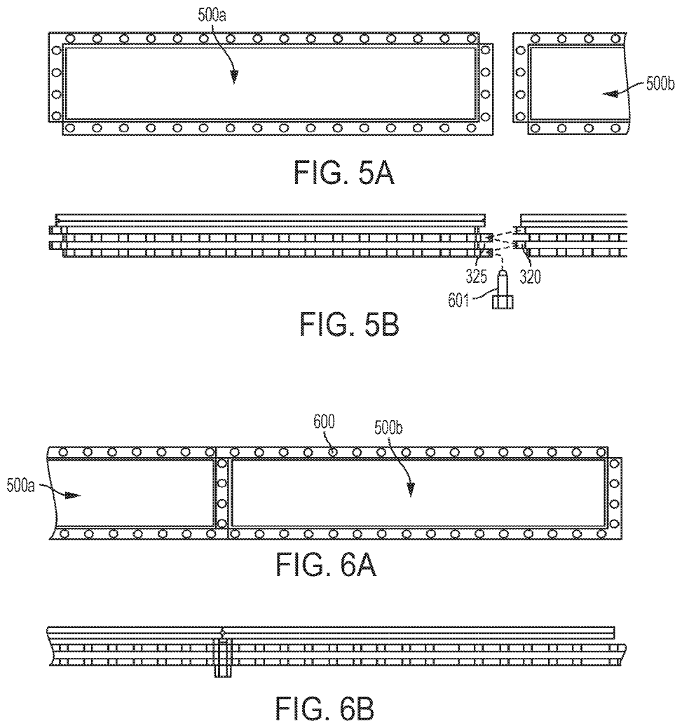

Referring to FIGS. 5A-B and, 6A-B there is seen a top and side view of two housings of the present disclosure. A first housing 500a comprises at least one recess 325, and a second housing 500b comprises at least one protrusion 320. At least one recess 325 can extend around the circumference of the first housing 500a. The at least one protrusion 320 can extend around the circumference of the second housing 500b. As represented by FIGS. 5A-B and 6A-B, with bottoms of both housings positioned along a common plane, at least one protrusion 320 of the second hosing 500b may be positioned along the plane so that it is received by the at least on recess 325 of housing 500a. In the configuration shown in FIG. 6, ends of the housings are joined such that sides of the housing are aligned along a common plane. When centrally disposed within an array, sides of the housing 500a and 500b can similarly be joined and aligned via insertion of the at least one protrusion 320 into the recess 325 of housing 500a. In an array of modules comprised of housings represented by FIGS. 5A-B and 6A-B, to remove a particular housing/module in particular row and particular column, those skilled in the art will recognize the continuous structure of 320 and 325 disclosed would require that additional housing/modules in that column be removed before the particular module of interest could be removed and replaced (for example, via sliding movement of a protrusion of one housing within the recess of another housing), however other modules not in the row and column the particular module of interest was disposed in would not necessarily need to be disturbed or moved from their position in the array. In one embodiment, each housing 500a and 500b comprises at least one aperture 600. The aperture 600 is formed at regular intervals around the periphery of each modules, where after assembly of one or more of the modules 500a and 500b, at least one pin 601 could be inserted within the at least one aperture 600 to rigidly secure the housings together.

Thus, when modules 105 are coupled via the methods and structures described above, an interlocking of the housings may be achieved to form a structurally rigid array, whose modules and components can thereby easily be maintained in proper alignment relative to each other. The arrays can be preassembled as housings, as housings comprised of a ground plane, or in the form of modules. Further, after mounting as arrays, the housings, housings comprised of ground planes, modules and/or antennas could be replaced or added to the array quickly and easily. In doing so, the arrays as described herein enable quick and easy scaling of the arrays without a need for large number of personnel, tools and effort that is currently need to increase communication network capacity.

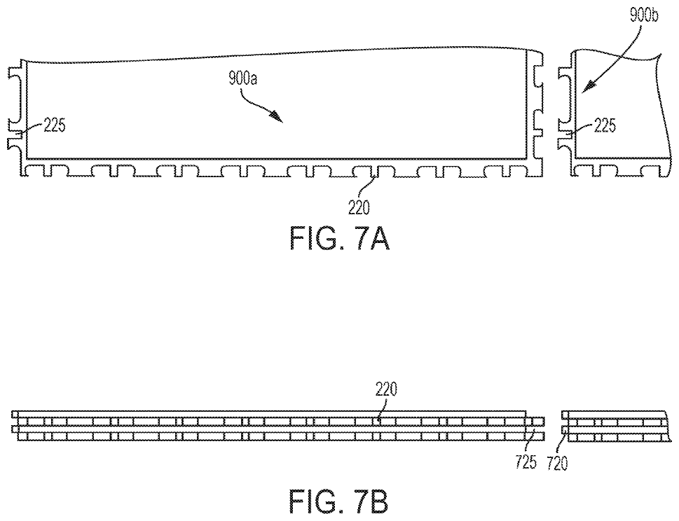

With reference to FIGS. 7A-B, there is seen a representation of a top and side view of housings 900a and 900b. The housing 900a comprises a fastening structure comprised of at least one protrusion comprised of 220 and 720 and at least one recess comprised of 225 and 725. With reference to the description of drop-in and pull-out movement of one housing relative to another one housing in FIG. 4 and with reference to the sliding movement of one housing relative to another in FIGS. 5A-B and 6A-B, the embodiment in FIGS. 7A-B enable one or both such movements, where sliding movement of 720 of one housing within 725 of another housing is enabled by the combination of the two different types of protrusions and recesses as individually described above.

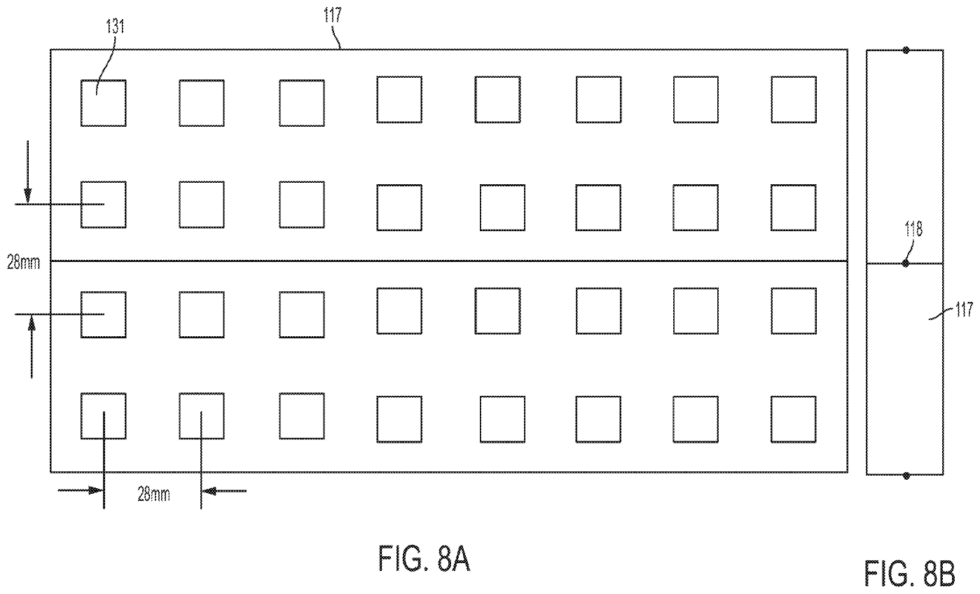

With reference to FIG. 8A, there is seen a top view of a representation of the geometrical relationship between adjacent antennas 131 of each antenna module when adjacent the ground planes 117 of the adjacent housings are coupled to each other. As can be understood from FIG. 8B, when two adjacent modules are coupled to each other, the same distance that is maintained between adjacent antennas 131 on each module is also maintained with respect antennas that are adjacent but in different adjacent modules. In other words, in an array of the modules 105 described herein, all adjacent antennas, whether they be in a module or an adjacent module, are separated from each other by the same distance. Thus, when joined to each other using techniques and structures described above, not only will the modules in the arrays of FIGS. 2A-E be precisely aligned to each other, but as well, all the antennas in the arrays would be aligned precisely with respect to each other; thereby obviating the need for precise alignments to be made between the antennas and modules during assembly of the arrays and/or during replacement or addition of individual modules within the array. Equal spacing between adjacent antennas in a module and between adjacent antennas in adjacent modules enables efficiency to be increased and interference to be reduced by avoiding the excitation of grating lobes.

With reference to FIG. 8B, there is seen a cross-sectional end view of a representation of two ground planes of the present disclosure. In an array of modules 105, when one ground plane 117 is positioned against another ground plane, conductive material disposed on the exterior of each ground plane, for example within a groove along the exterior of the ground plane, makes contact with conductive material on an adjacent ground plane. When the conductive material comprises an elastomeric material, during sliding insertion of one housing or module with respect to another module causes each conductive material to compress within the respective groove it is disposed in to allow each ground plane to slide past the other. Thereafter, the elastic and conductive properties of the conductive material ensures good electrical contact is maintained between the ground planes, wherein an array of such ground planes, conductivity between all the ground planes would be maintained.

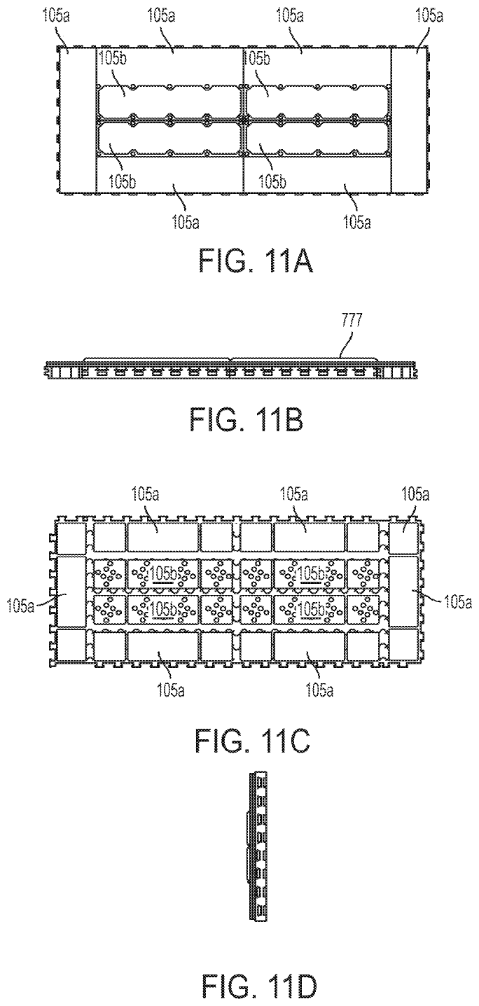

Referring to FIGS. 11A-D, there is seen a representations of a ground plane of the present disclosure. FIGS. 11A-D provide respective representations of a top view, an end view, a side view and a bottom view of an array formed of housings and modules of the present disclosure. In one embodiment, a periphery defined by housings 105b is coupled to housings 105a. In one embodiment housings 105b comprise one or more antennas mounted under a cover 777 of the housings (shown as 131 in FIG. 8A). Housings 105a comprise no antenna modules. In some configurations, housings 105a and 105b comprise ground planes, as is described according to the embodiments above. Housings 105b are comprised of ground antennas according to the embodiments above. Additionally, housings 105a are coupled to 105b and encircle the entire periphery of the housings 105b. The ground planes of all the housings 105a and 105b are coupled via their conductive material, as is described according to the embodiments above, to form a continuous ground plane that extends under and around the housings 105b. In doing so, the ground planes of 105a act as ground plane extensions to the ground planes of 105b. Housings 105a enable optimization of the antenna field pattern of antennas that are along the edges of the housings 105b (see, for example, antennas 131 disposed along sides of the edges of the housings in FIG. 8A). The length and width of 105a and 105b is the same. Alternatively, the length and/or width of 105a may be dimensioned to be different to accommodate coupling to a different numbers of housings 105b. The width of 105a may be may dimensioned to be different from that of 105b as may be needed to optimize the field pattern of the antennas of 105b. The one or more antennas of 105b define an array of evenly spaced antennas that is supported by the ground planes of 105b and further supported by the ground planes of 105a. Although four housings 105a and six housings 105b are represented by FIGS. 11A-D, other numbers of housings 105a and 105b are understood to be within the scope of the disclosure.

Using the structures and methodologies above, arrays of housings and modules 105, for example, those shown in FIG. 2, may be easily and quickly reconfigured without major design of hardware to produce desired beam width that can sufficiently illuminate a desired region of communication. With the quick and easy reconfigurability provided by the present disclosure, arrays of modules 105 can serve multiple applications but retain the same basic module design between modules.

This ability is described by a reference design, which consists of an array comprised of 2 by 8 modules, each with dual orthogonal polarization. In a first example, a point-to-multipoint wireless link may be implemented in which a panel of antennas provides service to a quadrant, i.e. a 90° beam width, in which a number of transceivers with fixed user antennas are located within a 90° width of the panel and within some radius, say 20 km. The ability to beamform with narrow beam widths in the azimuth is typically needed in order to be able to discriminate between nearby user antennas. To achieve such a beam width, multiple modules 105 may be attached together to form an array that is wide and short. For example as an array of 2×8N antennas. When implemented with more than 8 modules, this arrangement would form a 2×64 array of dual polarization antennas, which would require a set of 256 quadrature transceivers and digital processing required to drive the IQ inputs of each transceiver. The above is an example of where one dimensional (horizontal) beamforming could be effectuated with a minimal amount of vertical steerability needed to avoid ground bounce multipath fading. In a second example, a large building consisting of a number of floors is to have a high speed wireless service added by employing the reference design panels in a manner so as to be exterior to the building and directed toward it. A number of users are located at various locations on the different floors of the building and could be fixed or mobile. In this case, the modules would be shaped in a rectangular configuration so that the modules can form linear combinations of beams that are narrow in both the vertical and horizontal directions. The size, N×M of the rectangle would depend on the number of elements in each direction needed to realize a narrow enough beam width to again discriminate between individual users in close proximity.

The present disclosure also enables quick deployment and/or disassembly of high capacity radio networks. This is useful for applications such as military operations, disaster relief, outdoor venues such as music festivals, and other temporary deployments as needed. The present disclosure also reduces the cost of installation in general, and reduces rollout time by simplifying and reducing the labor needed to deploy new capacity.

The ability to easily add communication capacity, i.e. capacity aggregation, may be implemented as is further discussed below. For example, by extending an existing radio set by adding modules 105 to the set, which would be under the same control as an original Massive MIMO radio controller and such that the antennas of each array would all be treated as belonging to the same set, and such that the radio controller would use coherent channel state information for all antennas to produce optimum weights for all; or by adding a completely new radio set, which would operate in a different sub-band (or use different spreading code, etc.) than the existing capacity and require an independent computing resource (of course this could be another processor thread of an existing radio controller or another processor entirely.) As an example of capacity aggregation, consider a case where a line of arrays is arranged horizontally. In this case, the installer could remove the ground extensions from the bottom of an existing array, fasten on another line of modules to an existing array, and replace the ground extensions and remount them to infrastructure. The new line of modules could then be used as a completely new radio set as above and the capacity doubled.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A system, comprising:
M housings, where M is equal to or greater than 2, each of the housings comprising a ground plane, each of the housings being coupled to at least one other of the housings to form an array that is self-supporting in free space, at least one of the housings comprising an antenna.

2. The system of claim 1, wherein the array comprises a periphery defined by at least one of the housings.

3. (canceled)

4. The system of claim 1, wherein the at least one antenna comprises an assembly of antennas.

5. The system of claim 4, wherein the assembly of antennas comprises a plurality of antennas disposed in a grid, and wherein a center to center spacing between each antenna in the grid relative to a spatially opposite antenna in the grid is substantially the same.

6. The system of claim 2, wherein at least one of the housings does not comprise any antennas, wherein the periphery is defined at least in part by the at least one of the housings that does not comprise any antennas, and wherein the at least one housing that does not comprise any antennas is coupled to the at least one of the housings comprising an antenna.

7-15. (canceled)

16. The system of claim 1, wherein all of the housings in the array are the same size.

17. The system of claim 1, wherein each of the housings in the array comprise an exterior surface including at least one fastening structure configured to fasten adjacent housings in the array to each other.

18-30. (canceled)

31. The system of claim 1, wherein the ground planes of each of the housings are disposed in a common plane.

32-60. (canceled)

61. An antenna module, the antenna module comprising:
a first housing having an exterior surface comprising a fastening structure configured to be mated to a fastening structure of a second housing, the at least one fastening structure of the first housing defining at least a portion of an aperture when the first fastening structure is mated to the fastening structure of the second housing;
a ground plane; and
at least one antenna.

62. (canceled)

63. The antenna module of claim 61, wherein the module comprises a plurality of antennas arranged in a grid, wherein adjacent antennas in the grid are spaced apart from one another by the same distance.

64. (canceled)

65. A system of M modules, where M is equal to or greater than 2, each module comprising:
a housing, the housing having an exterior surface including a fastening structure comprising at least one protrusion and at least one recess, the fastening structure of the housing configured to mate with a fastening structure of a housing of at least one other module in the system;
an antenna assembly;
a ground plane, the housing joined to the ground plane, the ground plane joined to the antenna assembly; and
a conductive material.

66. The system of claim 65, wherein the fastening structures of two adjacent housings define at least one aperture, the at least one aperture configured to receive a portion of at least one fastener.

67-68. (canceled)

69. The system of claim 65, wherein the conductive material is disposed within a groove formed in a periphery of the ground plane.

70. The system of claim 65, wherein the modules are physically coupled to form an array comprised of rows and columns of modules, and wherein the modules are physically coupled by coupling of at least one protrusion or at least one recess of a module within the array with at least one recess or at least one protrusion of at least one other module in the array.

71. The system of claim 69, wherein the conductive material defines a periphery of each module, wherein the conductive material of each module in the array is in electrical communication with the conductive material of at least one other module in the array to enable electrical conductivity between all of the ground planes in the array.

72. The system of claim 71, wherein the conductive material comprises an elastomer.

73. The system of claim 65, wherein any module within a particular row and column of the array can be decoupled from that row and column that without requiring removal of other modules in the array that are not in that row or that column.

74-75. (canceled)

76. The system of claim 65, wherein at least some of the housings comprise an antenna assembly comprising a plurality of individual antennas disposed in a grid, and wherein a center to center spacing between each individual antenna in the grid relative to spatially opposite antennas in the grid is substantially the same.

77-78. (canceled)

79. The system of claim 76, wherein the center to center spacing is about 28 mm.

80. The system of claim 76, wherein the center to center spacing of effectuates operation of the antennas between about 5.375-6.375 GHz.

81-100. (canceled)
